(19) United States
(12) Patent Application Publication
(10) Pub. No.: US 2007/0171864 A1
(43) Pub. Date: Jul. 26, 2007

(54) METHOD AND APPARATUS FOR MAPPING AN UPLINK CONTROL CHANNEL TO A PHYSICAL CHANNEL IN A SINGLE CARRIER FREQUENCY DIVISION MULTIPLE ACCESS SYSTEM

(75) Inventors: Guodong Zhang, Farmingdale, NY (US); Yingming Tsai, Boonton, NJ (US); Jung-Lin Pan, Selden, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/623,795

(22) Filed: Jan. 17, 2007

Related U.S. Application Data
(60) Provisional application No. 60/759,408, filed on Jan. 17, 2006.

(51) Int. Cl. H04Q 7/00

(52) U.S. Cl. 370/329

(57) ABSTRACT

A method and apparatus for mapping an uplink control channel to a physical channel in a single carrier frequency division multiple access (SC-FDMA) system are disclosed. A wireless transmit/receive unit (WTRU) generates control bits to be carried by a control channel. The WTRU maps the control channel to a plurality of subcarriers among subcarriers in a resource block assigned to the WTRU and to at least one long block (LB) in a sub-frame. The control channel includes a data-non-associated control channel and/or a data-associated control channel. The subcarriers mapped to the data-non-associated control channel may be distributed over all, or a fraction of, at least one resource block. The data-non-associated control channel may be mapped to the subcarriers with one or more subcarriers as a basic unit. The mapped subcarriers may be consecutive in frequency domain. The control bits may be multiplexed with data bits within the LB.

### CROSS REFERENCE TO RELATED APPLICATION

This application claims the benefit of U.S. Provisional Application No. 60/759,408 filed Jan. 17, 2006, which is incorporated by reference as if fully set forth.

### FIELD OF INVENTION

The present invention is related to wireless communication systems. More particularly, the present invention is related to a method and apparatus for mapping an uplink control channel to a physical channel in a wireless communication system implementing single carrier frequency division multiple access (SC-FDMA).

### BACKGROUND

Developers of third generation (3G) wireless communication systems are considering long term evolution (LTE) of the 3G systems to develop a new radio access network for providing a high-data-rate, low-latency, packet-optimized, improved system with higher capacity and better coverage. In order to achieve these goals, instead of using code division multiple access (CDMA), which is currently used in 3G systems, SC-FDMA is proposed as an air interface for uplink transmission in LTE.

The basic uplink transmission scheme in LTE is based on a low peak-to-average power ratio (PAPR) SC-FDMA transmission with a cyclic prefix (CP) to achieve uplink inter-user orthogonality and to enable efficient frequency-domain equalization at the receiver side. Both localized and distributed transmission may be used to support both frequency-adaptive and frequency-diversity transmission.

FIG. 1 shows a basic sub-frame structure for uplink transmission proposed in LTE. The sub-frame includes six long blocks (LBs) 1-6 and two short blocks (SBs) 1 and 2. The SBs 1 and 2 are used for reference signals, (i.e., pilots), for coherent demodulation and/or control or data transmission. The LBs 1-6 are used for control and/or data transmission. A minimum uplink transmission time interval (TTI) is equal to the duration of the sub-frame. It is possible to concatenate multiple sub-frames into longer uplink TTI.

One of the key problems to be addressed in LTE is physical channel mapping of the uplink control channel. Therefore, it would be desirable to provide a method and apparatus for implementing efficient physical channel mapping for the control information in an SC-FDMA system.

### SUMMARY

The present invention is related to a method and apparatus for mapping an uplink control channel, (i.e., control signaling), to a physical channel in a wireless communication system implementing SC-FDMA. A wireless transmit/receive unit (WTRU) generates control bits to be carried by a control channel. The WTRU maps the control channel to a plurality of subcarriers among subcarriers in a resource block assigned to the WTRU and to at least one LB in a sub-frame. The control channel includes a data-non-associated control channel and/or a data-associated control channel. The subcarriers mapped to the data-non-associated control channel may be distributed over all, or a fraction of, at least one resource block. The data-non-associated control channel may be mapped to the subcarriers with one or more subcarriers as a basic unit. The mapped subcarriers may be consecutive in frequency domain. The control bits may be multiplexed with data bits within the LB.

### BRIEF DESCRIPTION OF THE DRAWINGS

FIG. 1 shows a conventional sub-frame format of SC-FDMA.

FIG. 2 is a block diagram of a system configured in accordance with the present invention.

FIGS. 3 and 4 show mapping of a data-non-associated control channel to a physical channel over an entire resource block(s) when there is no uplink user data transmission in accordance with the present invention.

FIGS. 5 and 6 show mapping of a data-non-associated control channel to a physical channel over a fraction of a resource block where there is no uplink user data transmission in accordance with the present invention.

FIG. 7 shows mapping of a data-non-associated control channel to a plurality of consecutive subcarriers when there is no uplink user data transmission in accordance with the present invention.

FIG. 8 shows mapping of a control channel to a physical channel when there is uplink user data transmission in accordance with one embodiment of the present invention.

FIGS. 9 and 10 show mapping of a control channel to a physical channel when there is uplink user data transmission in accordance with another embodiment of the present invention.

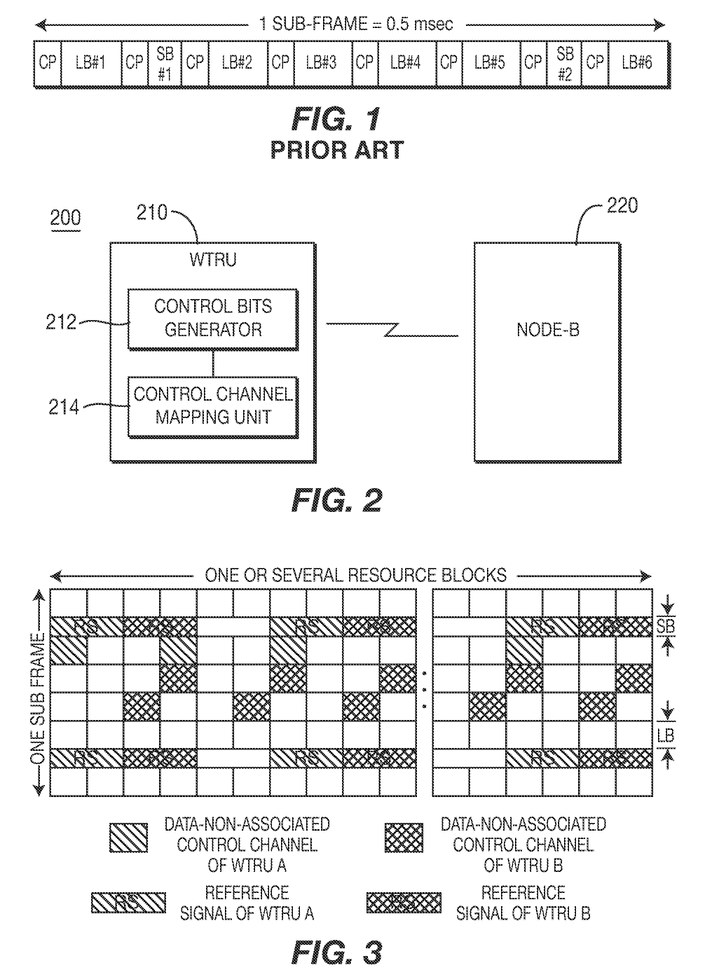

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a notebook computer, a personal data assistance (PDA), or any other type of user device capable of operating in a wireless environment. When referred to hereafter, the terminology “Node-B” includes but is not limited to a base station, a site controller, an access point (AP), or any other type of interfacing device capable of operating in a wireless environment.

The features of the present invention may be incorporated into an integrated circuit (IC) or be configured in a circuit comprising a multitude of interconnecting components.

FIG. 2 is a block diagram of a system 200 configured in accordance with the present invention. The system 200 includes a WTRU 210 and a Node-B 220. SC-FDMA is implemented for uplink transmission from the WTRU 210 to the Node-B 220. The Node-B 220 assigns radio resources to the WTRU 210 for uplink transmission. The WTRU 210 includes a control bits generator 212 and a control channel mapping unit 214. The control bits generator 212 generates control information. The control channel mapping unit 214 maps a control channel, (i.e., control signaling), for carrying the control information to a physical channel.

The control information includes data-associated control information which is carried on a data-associated control channel and data-non-associated control information which is carried on a data-non-associated control channel. The data-associated control information includes uplink transport format information, hybrid automatic repeat request (H-ARQ) information, or the like. The data-non-associated control information includes channel quality information (CQI), H-ARQ feedback for downlink data transmission, uplink scheduling information, or the like. An uplink channel that transmits CQI is called a CQICH and an uplink channel that transmits an H-ARQ feedback is called an ACKCH.

The WTRU 210 measures CQI on downlink transmissions and reports the CQI to the Node-B 220 via the CQICH. The reported CQI is used by the Node-B 220 for scheduling downlink transmissions. After decoding downlink data transmission, the WTRU 210 sends an H-ARQ feedback, (i.e., either a positive acknowledgement (ACK) or a negative acknowledgement (NACK)), to the Node-B 220 via the ACKCH to inform whether the corresponding H-ARQ transmission is successful or not.

For the transmission of the data-non-associated control information, the following data-non-associated control channels may be provided to the WTRU 210.

1) A standalone ACKCH to transmit an ACK or a NACK feedback corresponding to downlink data transmission;

2) A standalone type 1 CQICH to transmit average downlink CQI information of the entire bandwidth to the Node-B 220 for its downlink scheduling.

3) A standalone type 2 CQICH to transmit K best CQI along with locations of the resource blocks with the K best CQI;

4) A standalone type 3 CQICH to transmit CQI used for closed loop multiple-input multiple-output (MIMO) operation and locations of the downlink resource blocks;

5) A standalone type 4 CQICH to transmit CQI used for open loop MIMO operation and locations of the downlink resource blocks;

6) A standalone composite CQICH to report several types of CQI at the same time defined as standalone type 1, 2, 3 or 4 CQICHs, (i.e., any combination of CQICHs);

7) an extended CQICH (of type 1, 2, 3, 4, or composite) to transmit the H-ARQ feedback information in addition to the CQI; and

8) An extended ACKCH to transmit one or several types of CQI information together with the H-ARQ feedback.

The WTRU 210 may be configured to have only one standalone ACKCH, only one standalone CQICH of any type (type 1, 2, 3, 4 and composite), one standalone ACKCH and one standalone CQICH of any type (type 1, 2, 3, 4 and composite), only one extended CQICH of any type (type 1, 2, 3, 4 and composite), or only one extended ACKCH. Depending on the amount of uncoded bits, Reed-Muller coding or convolutional coding may be applied for encoding the CQI, and repetition coding may be applied for encoding the H-ARQ feedback. If the CQI and the H-ARQ feedback are transmitted via the same control channel, the H-ARQ feedback and the CQI may be coded separately.

FIG. 3 shows mapping of a data-non-associated control channel to a physical channel over an entire resource block(s) when there is no uplink user data transmission in accordance with the present invention. In frequency domain, the data-non-associated control channel is mapped to a plurality of subcarriers distributed over the entire resource block(s) assigned to a WTRU. A resource block comprises a plurality of localized or distributed subcarriers. Preferably, the data-non-associated control channel is mapped to subcarriers separated with an equal spacing to provide good frequency diversity. In time domain, depending on the number of coded bits to be transmitted via the data-non-associated control channel, the data-non-associated control channel may be mapped to one or several LBs in a sub-frame.

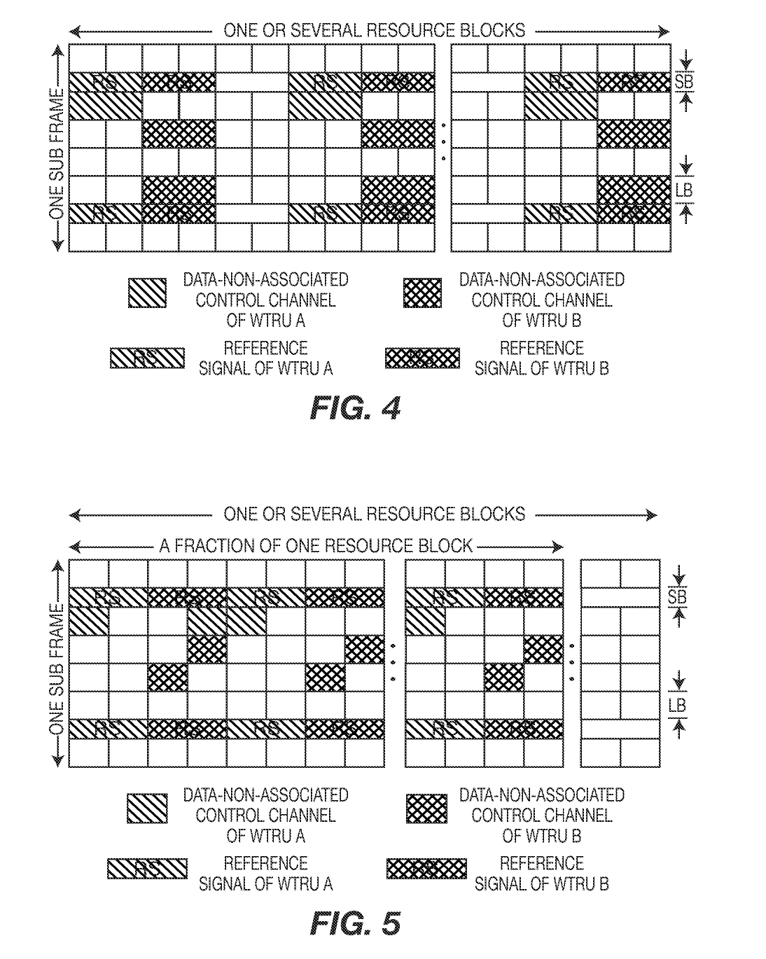

The subcarriers may be mapped to the data-non-associated control channel by using one subcarrier as a basic unit, as shown in FIG. 3. Alternatively, the basic unit may be several consecutive subcarriers as shown in FIG. 4. In FIG. 4, two consecutive subcarriers are used as a basic unit to be mapped to the data-non-associated control channel. Compared to the channel mapping configuration in FIG. 3, it may save overhead or may have better channel estimation performance at the receiver due to less frequency domain interpolation at channel estimation.

Each subcarrier mapped for the data-non-associated control channel may or may not be in the same frequency position as the uplink reference channel. As shown in FIG. 3, subcarriers mapped to the data-non-associated control channel for a WTRU and subcarriers for the reference signal for the WTRU may not completely overlap each other. Alternatively, as shown in FIG. 4, the subcarriers mapped to the data-non-associated control channel for a WTRU may be same to subcarriers for the reference signal for the WTRU.

FIG. 5 shows mapping of a data-non-associated control channel to a physical channel over a fraction of a resource block when there is no uplink user data transmission in accordance with the present invention. In frequency domain, the data-non-associated control channel is mapped to subcarriers distributed over a fraction of the entire resource block(s). Preferably, the data-non-associated control channel is mapped to subcarriers separated with an equal spacing to provide good frequency diversity. This solution allows trade-off between frequency diversity and signaling overhead. In time domain, depending on the number of coded bits to be transmitted via the data-non-associated control channel, the data-non-associated control channel may be mapped to one or several LBs in a sub-frame.

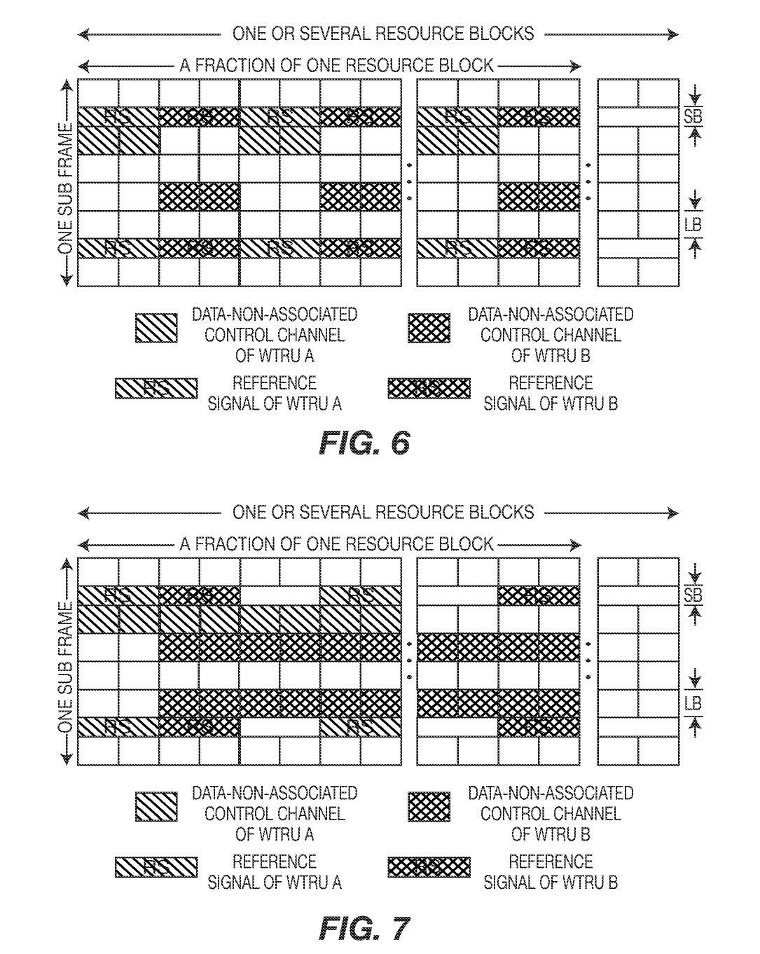

The subcarriers may be mapped to the data-non-associated control channel by using one subcarrier as a basic unit, as shown in FIG. 5. Alternatively, the basic unit may be several consecutive subcarriers as shown in FIG. 6. Each subcarrier mapped to the data-non-associated control channel of a WTRU may or may not be in the same frequency position as the uplink reference channel of the WTRU.

FIG. 7 shows mapping of a data-non-associated control channel to a plurality of consecutive subcarriers when there is no uplink user data transmission in accordance with the present invention. In frequency domain, the data-non-associated control channel may be mapped to a plurality of consecutive subcarriers in one or more resource blocks assigned to the WTRU to minimize the signaling overhead. In time domain, depending on the number of coded bits carried on the data-non-associated control channel, the data-non-associated control channel may be mapped to one or several LBs in a subframe.

Mapping of a control channel to a physical channel when there is uplink user data transmission is explained hereinafter. When there is uplink user data transmission, at least one resource block is assigned to a WTRU for transmission of the uplink user data. With respect to the control channel mapping, there are two options. First, all data-non-associated control channels are mapped to the subcarriers in the assigned resource block(s) used for the uplink user data transmission. Alternatively, at least one data-non-associated control channel may be mapped to subcarriers not within the assigned resource block(s) used for the uplink user data transmission.

When all data-non-associated control channels are mapped to subcarriers within the resource block(s) used for the uplink user data transmission, the number of control bits, (i.e., data-associated control bits and data-non-associated control bits), may or may not fit into integer number of LBs. If the number of control bits fit into integer (H) number of LBs, the control bits may be mapped to first H LBs and no data bits are mapped to the first H LBs. If the number of control bits does not fit into integer number of LBs, the control bits may be multiplexed with data bits within one LB or several LBs, (i.e., within one or several OFDM symbols).

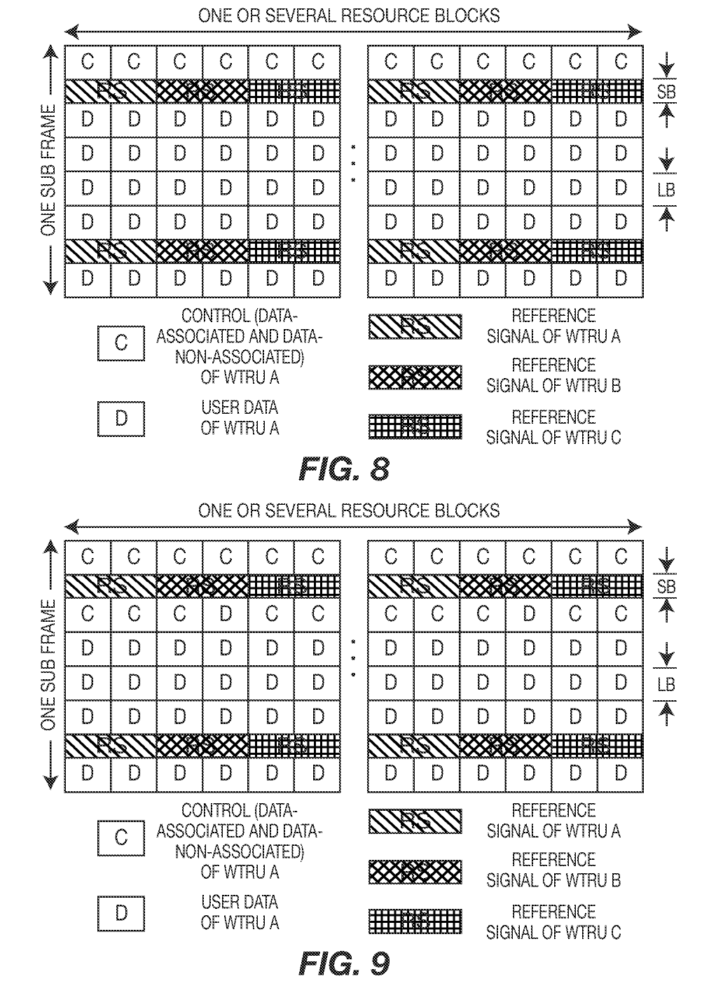

FIG. 8 shows mapping of a control channel to a physical channel when there is uplink user data transmission in accordance with one embodiment of the present invention. In this case, all data-non-associated control channels are mapped to subcarriers within the resource block(s) used for uplink user data transmission and the number of control bits fits into one LB. Therefore, the control bits are mapped to the first LB and no data bits are mapped to the first LB. The data bits are mapped to the following LBs.

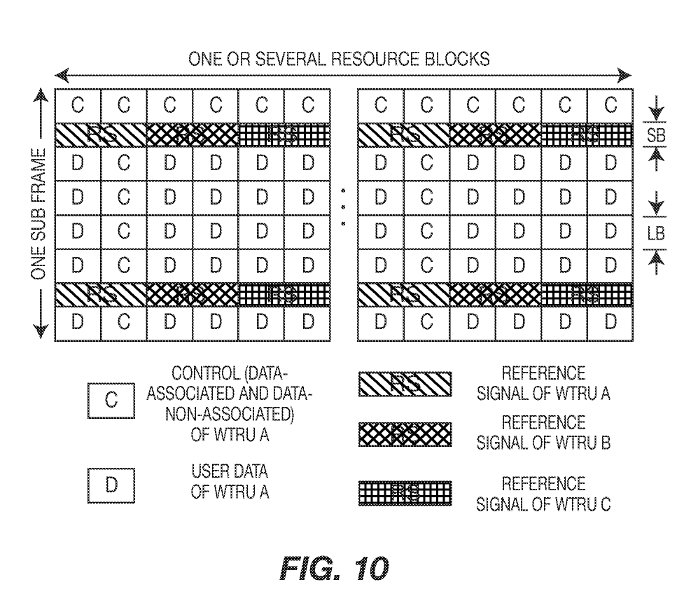

FIGS. 9 and 10 show mapping of a control channel to a physical channel when there is uplink user data transmission in accordance with another embodiment of the present invention. In this case, all data-non-associated control channels are mapped to subcarriers within the resource block(s) used for uplink user data transmission and the number of control bits does not fit into integer number of LBs. Therefore, some control bits are multiplexed with data bits in one LB. When control information is transmitted in more than one LB, time critical control information should be transmitted earlier than non-time critical control information.

If the control bits that are multiplexed with data bits occupy most subcarriers in an LB in the resource block assigned for uplink user data transmission, a fast Fourier transform (FFT) size for the control bits should be much larger than the FFT size for the data bits in order to keep the PAPR low. An example for this case (with H=2) is shown in FIG. 9.

If the control bits that are multiplexed with data bits occupy only a small portion of subcarriers in an LB in the resource block assigned for uplink user data transmission, an FFT size for the control bits should be much smaller than the FFT size for the data bits in order to keep the PAPR low. An example for this case (with H=6) is shown in FIG. 10.

When at least one data-non-associated control channel is mapped to subcarriers not within the resource block(s) used for the uplink data transmission, the ratio of the FFT size for control bits and the FFT size for data bits should be kept either large or small to keep the PAPR for the WTRU low in the uplink. In a particular LB, if the number of subcarriers occupied by the control bits in the resource block(s) used for uplink data transmission is much smaller than the number of subcarriers occupied by user data bits, the number of the out-of-the-resource-block-subcarriers mapped for the data-non-associated control channel should be restricted to keep the FFT size ratio small for the WTRU. In a particular LB, if the number of subcarriers occupied by the control bits in the resource block(s) used for uplink data transmission is much larger than the number of subcarriers occupied by the user data bits, the data-non-associated control channel(s) not mapped to subcarriers in the resource block(s) used for the uplink data transmission may use as many subcarriers as possible.

In any of the foregoing embodiments, time and/or frequency hopping may be applied for time and/or frequency diversity.

Although the features and elements of the present invention are described in the preferred embodiments in particular combinations, each feature or element can be used alone without the other features and elements of the preferred embodiments or in various combinations with or without other features and elements of the present invention. The methods provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for in use in a WTRU, user equipment, terminal, base station, radio network controller, or any host computer. The WTRU may be used in conjunction with modules, implemented in hardware and/or software, such as a camera, a videocamera module, a videophone, a speakerphone, a vibration device, a speaker, a microphone, a television transceiver, a handsfree headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system where single carrier frequency division multiple access (SC-FDMA) is used for uplink transmission from a wireless transmit/receive unit (WTRU) to a Node-B, a method for mapping an uplink control channel to a physical channel, the method comprising:
generating control bits to be carried by at least one control channel; and
mapping the control channel to a plurality of subcarriers among subcarriers in a resource block assigned to a WTRU and to at least one long block (LB) in a sub-frame.

2. The method of claim 1 wherein the control channel includes at least one of a data-non-associated control channel and a data-associated control channel.

3. The method of claim 2 wherein the data-non-associated control channel carries at least one of a hybrid automatic repeat request (H-ARQ) feedback and channel quality information (CQI).

4. The method of claim 3 wherein the CQI indicates an average channel quality of an entire bandwidth.

5. The method of claim 3 wherein the CQI indicates channel quality of K resource blocks having K best channel quality.

6. The method of claim 3 wherein the CQI indicates channel quality for a closed loop multiple-input multiple-output (MIMO).

7. The method of claim 3 wherein the CQI indicates channel quality for an open loop multiple-input multiple-output (MIMO).

8. The method of claim 3 wherein the H-ARQ feedback and the CQI are coded separately.

9. The method of claim 2 wherein the subcarriers mapped to the data-non-associated control channel are distributed over at least one resource block.

10. The method of claim 9 wherein the subcarriers are distributed with an equal spacing.

11. The method of claim 9 wherein the data-non-associated control channel is mapped to the subcarriers with one subcarrier as a basic unit.

12. The method of claim 9 wherein the data-non-associated control channel is mapped to the subcarriers with several consecutive subcarriers as a basic unit.

13. The method of claim 2 wherein the subcarriers mapped to the data-non-associated control channel are distributed over a fraction of one resource block.

14. The method of claim 2 wherein the subcarriers mapped to the data-non-associated control channel are consecutive in frequency domain.

15. The method of claim 1 further comprising
applying at least one of time hopping and frequency hopping in mapping the control channel.

16. The method of claim 2 wherein all data-non-associated control channels are mapped to subcarriers in a resource block used for uplink user data transmission.

17. The method of claim 16 wherein the control bits are mapped to first H LBs and no data bits are mapped to the first H LBs.

18. The method of claim 16 wherein the control bits are multiplexed with data bits within at least one LB.

19. The method of claim 18 wherein if the control bits that are multiplexed with data bits occupy most subcarriers in the resource block used for uplink user data transmission, a fast Fourier transform (FFT) size for the control bits is much larger than an FFT size for the data bits, and if the control bits that are multiplexed with data bits occupy only a small portion of subcarriers in the resource block used for uplink user data transmission, an FFT size for the control bits is much smaller than an FFT size for the data bits.

20. The method of claim 2 wherein at least one data-non-associated control channel is mapped to subcarriers not within a resource block used for uplink user data transmission.

21. The method of claim 20 wherein if the number of subcarriers occupied by control bits in the resource block used for uplink data transmission is much smaller than the number of subcarriers occupied by data bits, the number of subcarriers mapped to the data-non-associated control channel not within the resource block used for uplink data transmission is restricted.

22. The method of claim 20 wherein if the number of subcarriers occupied by control bits in the resource block assigned for uplink data transmission is much larger than the number of subcarriers occupied by data bits, the data-non-associated control channel not mapped to subcarriers in the resource block used for the uplink data transmission uses as many subcarriers as possible.

23. The method of claim 1 wherein the system is an evolved universal terrestrial radio access (E-UTRA) system.

24. In a wireless communication system where single carrier frequency division multiple access (SC-FDMA) is used for uplink transmission from a wireless transmit/receive unit (WTRU) to a Node-B, an apparatus for mapping uplink control bits to a physical channel, the apparatus comprising:
a control bit generator for generating control bits to be carried by at least one control channel; and
a control channel mapping unit for mapping the control channel to a plurality of subcarriers among subcarriers in a resource block assigned to a WTRU and to at least one long block (LB) in a sub-frame.

25. The apparatus of claim 24 wherein the control bit generator is configured to generate at least one of data-non-associated control bits and data-associated control bits.

26. The apparatus of claim 25 wherein the data-non-associated control bits include at least one of a hybrid automatic repeat request (H-ARQ) feedback and channel quality information (CQI).

27. The apparatus of claim 26 wherein the CQI indicates an average channel quality of an entire bandwidth.

28. The apparatus of claim 26 wherein the CQI indicates channel quality of K resource blocks having K best channel quality.

29. The apparatus of claim 26 wherein the CQI indicates channel quality for a closed loop multiple-input multiple-output (MIMO).

30. The apparatus of claim 26 wherein the CQI indicates channel quality for an open loop multiple-input multiple-output (MIMO).

31. The apparatus of claim 26 wherein the H-ARQ feedback and the CQI are coded separately.

32. The apparatus of claim 25 wherein the control channel mapping unit is configured to distribute the subcarriers mapped to the data-non-associated control channel over at least one resource block.

33. The apparatus of claim 32 wherein the control channel mapping unit is configured to distribute the subcarriers mapped to the data-non-associated control channel with an equal spacing.

34. The apparatus of claim 32 wherein the control channel mapping unit is configured to distribute the subcarriers mapped to the data-non-associated control channel with one subcarrier as a basic unit.

35. The apparatus of claim 32 wherein the control channel mapping unit is configured to distribute the subcarriers mapped to the data-non-associated control channel with several consecutive subcarriers as a basic unit.

36. The apparatus of claim 25 wherein the control channel mapping unit is configured to distribute the subcarriers mapped to the data-non-associated control channel over a fraction of one resource block.

37. The apparatus of claim 25 wherein the control channel mapping unit is configured to map subcarriers consecutive in frequency domain to the data-non-associated control channel.

38. The apparatus of claim 24 wherein the control channel mapping unit is configured to apply at least one of time hopping and frequency hopping in mapping the control channel.

39. The apparatus of claim 25 wherein the control channel mapping unit is configured to map all data-non-associated control channels to subcarriers in a resource block used for uplink user data transmission.

40. The apparatus of claim 39 wherein the control channel mapping unit is configured to map the data-non-associated control channels to first H LBs and no data bits are mapped to the first H LBs.

41. The apparatus of claim 39 wherein the control channel mapping unit is configured to multiplex the control bits with data bits within at least one LB.

42. The apparatus of claim 41 wherein if the control bits that are multiplexed with data bits occupy most subcarriers in the resource block used for uplink user data transmission, a fast Fourier transform (FFT) size for the control bits is much larger than an FFT size for the data bits, and if the control bits that are multiplexed with data bits occupy only a small portion of subcarriers in the resource block used for uplink user data transmission, an FFT size for the control bits is much smaller than an FFT size for the data bits.

43. The apparatus of claim 25 wherein the control channel mapping unit is configured to map at least one data-non-associated control channel to subcarriers not within a resource block used for uplink user data transmission.

44. The apparatus of claim 43 wherein the control channel mapping unit is configured to restrict the number of subcarriers mapped for the data-non-associated control channel not within the resource block used for uplink data transmission if the number of subcarriers occupied by control bits in the resource block used for uplink data transmission is much smaller than the number of subcarriers occupied by data bits.

45. The apparatus of claim 43 wherein the control channel mapping unit is configured to use as many subcarriers as possible for the data-non-associated control channel not mapped to subcarriers in the resource block used for the uplink data transmission if the number of subcarriers occupied by control bits in the resource block used for uplink data transmission is much larger than the number of subcarriers occupied by data bits.

46. The apparatus of claim 24 wherein the system is an evolved universal terrestrial radio access (E-UTRA) system.
